(19) United States
(12) Patent Application Publication
(10) Pub. No.: US 2017/0147228 A1
(43) Pub. Date: May 25, 2017

(54) COMPUTATION ALONG A DATAPATH BETWEEN MEMORY BLOCKS

(71) Applicant: Advanced Micro Devices, Inc., Sunnyvale, CA (US)

(72) Inventors: Dmitri Yudanov, Austin, TX (US); Sergey Blagodurov, Bellevue, WA (US); David A. Roberts, Sunnyvale, CA (US); Mitesh R. Meswani, Austin, TX (US); Nuwan Jayasena, Sunnyvale, CA (US); Michael Ignatowski, Austin, TX (US)

(21) Appl. No.: 14/952,517

(22) Filed: Nov. 25, 2015

(51) Int. Cl. G06F 3/06

(52) U.S. Cl. CPC G06F 3/0611; G06F 3/0635; G06F 3/0673

(57) ABSTRACT

A plurality of memory blocks are connected to a computation-enabled switch that provides data paths between the plurality of memory blocks. The computation-enabled switch performs one or more computations on data stored in one or more of the plurality of memory blocks during transfer of the data along one or more of the data paths between the plurality of memory blocks.

### BACKGROUND

Field of the Disclosure

The present disclosure relates generally to processing systems and, more particularly, to processing systems that include multiple memory blocks.

Description of the Related Art

Memory systems often include multiple memory blocks, such as caches, that are connected to a processor through a switch. For example, a heterogeneous memory system includes multiple individual memory blocks that operate according to different memory access protocols and could be implemented in different technologies. For another example, a homogeneous memory system may be formed of multiple individual memory blocks that operate according to the same memory access protocols. The individual memory blocks in a memory system typically share the same physical address space, which may be mapped to a corresponding virtual address range, so that the different individual memory blocks are transparent to the operating system of the device that includes the memory system. The memory blocks of the memory system can be packaged together as a single “black box” memory. For example, a heterogeneous memory system may include relatively fast (but high-cost) stacked dynamic random access memory (DRAM) and relatively high capacity (but slower and lower-cost) nonvolatile RAM (NVRAM) that are mapped to a single virtual address range. However, computations involving information stored in the memory system must be performed by an external processor that is connected to the memory system. Data transfers from the memory system to the external processor (prior to the computation) and back to the memory system (to store results of the computation) introduce significant latency into the computations.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system according to some embodiments.

FIG. 2 is a block diagram of a processor system including a processor package that includes one or more internal memory blocks and is connected to one or more external memory blocks according to some embodiments.

FIG. 3 is a block diagram of a processing system including an intelligent switch that implements an in-line compute element according to some embodiments.

FIG. 4 is a block diagram of a processing system including an intelligent switch that implements a side-by-side switch and compute element according to some embodiments.

FIG. 5 is a block diagram of a processing system including an intelligent switch that implements multiplexing of data provided to a compute element according to some embodiments.

FIG. 6 is a block diagram of a processing system including a processor chip that integrates an intelligent switching function with an integrated compute element according to some embodiments.

FIG. 7 is a block diagram of a portion of an intelligent switch according to some embodiments.

FIG. 8 is a flow diagram of a method for selectively performing computations on data along a data path between memory blocks or an external processor according to some embodiments.

### DETAILED DESCRIPTION

The movement of data (and the incurred corresponding latency and energy consumption) in a processing system that includes multiple memory blocks connected to a processor via a switch may be reduced by performing some computations on data stored in one or more of the memory blocks along a data path between the one or more memory blocks and one or more other memory blocks in the memory system. The data path bypasses the processor, thereby reducing the computation latency relative to the latency of performing the computation in the processor, as well as providing other benefits such as reductions in one or more of the number of memory accesses, data cached in a cache hierarchy associated with the processor, and a load on the processor. Some embodiments of the memory system include a computation-enabled switch (referred to herein as “an intelligent switch”) that is part of the data path and performs computations on data in addition to swapping, redirecting, or routing the data between the memory blocks of the memory system. In embodiments of the memory system that include different types of memory blocks that operate according to different protocols, the intelligent switch may improve memory access patterns by matching data types for variables in the executed instructions to memory types of the memory blocks. Examples of operations performed by the intelligent switch include rearrangement of data stored in the heterogeneous memory system, searches or other computations that do not modify the original data, error detection or correction, and initialization of portions of the memory blocks.

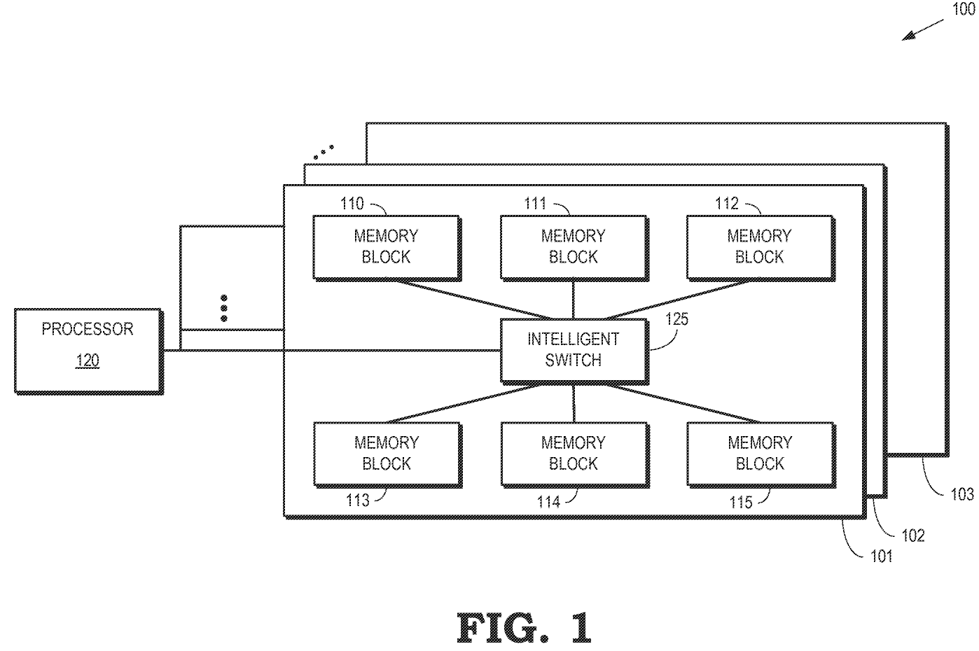

FIG. 1 is a block diagram of a processing system 100 according to some embodiments. The processing system 100 includes one or more memory modules 101, 102, 103 (referred to herein as “the memory modules 101-103”) that each include a plurality of memory blocks 110, 111, 112, 113, 114, 115 (referred to herein as “the memory blocks 110-115”). The memory blocks 110-115 may also be referred to as individual memory modules, memory banks, memory elements, and the like. Although three memory modules 101-103 are illustrated in FIG. 1, some embodiments of the processing system 100 may include more or fewer memory modules 101-103.

Some embodiments of the memory modules 101-103 are heterogeneous memory modules 101-103 that include subsets of the memory blocks 110-115 that include different types of memories that operate according to different memory access protocols and have different memory access characteristics. For example, the memory blocks 110-112 may be dynamic RAM (DRAM) that are relatively fast (e.g., lower memory access latencies) and have relatively low capacity. The memory blocks 113-115 may be nonvolatile random access memories (NVRAM) that are relatively slow but support a relatively high capacity (compared to the memory blocks 110-112). Some embodiments of the memory modules 101-103 are homogeneous memory modules 101-103 that include memory blocks 110-115 that implement the same type of memory and operate according to the same memory access protocols. The memory types implemented by the memory blocks 110-115 may also include high density drives (HDDs), solid state drives (SSDs), static RAM (SRAM), and the like.

The processing system 100 also includes one or more processors 120 for reading data or instructions from the memory blocks 110-115, executing instructions stored in the memory blocks 110-115 to perform operations on data received from the memory blocks 110-115, and writing data (such as the results of executed instructions) to the memory blocks 110-115. Some embodiments of the processor 120 are implemented using multiple processor cores. In some embodiments, the memory modules 101-103 and the processor 120 may each be fabricated on separate substrates, chips, or die.

The memory modules 101-103 implement intelligent switches 125 for moving data along data paths between the memory blocks 110-115. As used herein, phrases such as “moving data,” “movement of data,” “transferring data,” or “transfer of data” may refer to either moving a copy of the data (while another copy remains in storage in its original location) or moving the data so that the data is removed (or erased) from its original location and subsequently stored in a new location, perhaps in a modified form. The data paths between the memory blocks 110-115 do not include the processor 120 and data moved along these data paths therefore bypasses the processor 120. The intelligent switch 125 may also perform one or more computations on data stored in one or more of the memory blocks 110-115 as the data is moved or transferred along one or more of the data paths between the plurality of memory blocks 110-115. The intelligent switch 125 may also move data between the processor 120 and the memory blocks 110-115, e.g., to allow the processor 120 to perform other computations on the data. The intelligent switch 125 can therefore perform computations in a pipelined manner on the data while simultaneously or concurrently moving the data between the memory blocks 110-115 or the processor 120. Thus, the intelligent switch 125 performs the computations during transfer of the data between the memory blocks 110-115 or the processor 120.

In some embodiments, an application programming interface (API) is defined for the processing system 100. For example, if the memory modules 101-103 are heterogeneous memory modules, the API may allow a user to specify the type of memory associated with each allocated data, thereby allowing the user to specify the direction of data movement and the computation performed by the intelligent switch 125 as the corresponding data is moved. Using C++ syntax, the allocation of storage for integer variables to “capacity” memory or “fast” memory may be indicated as:

capacity int a=1,b=2;

fast int c=a+b; . . .

Memory type specification may be useful in applications such as the simulation of physical phenomena. For example, in a simulation of the interactions of atoms during nuclear reactions, the variables that specify the state of each atom are placed in the capacity memory and intermediate results are placed in fast memory. The state of each atom is updated and stored back immediately (no need to store it in the fast memory and bring to the host processor). The fast memory stores the intermediate results and the outcome of these results are forwarded to the processor 120 for further computation. The instructions would therefore have operands pointed to different memory types and the result of any computation in this memory system should be stored in a memory block 110-115 that implements the most appropriate type of memory, which may be determined by the user. Some embodiments of the intelligent switch 125 may not support sufficient compute capabilities for the total aggregated memory bandwidth required by the particular application. The intelligent switch 125 and the processor 120 may therefore coordinate operation and split the compute work while data is being cached in one of the memory blocks 110-115.

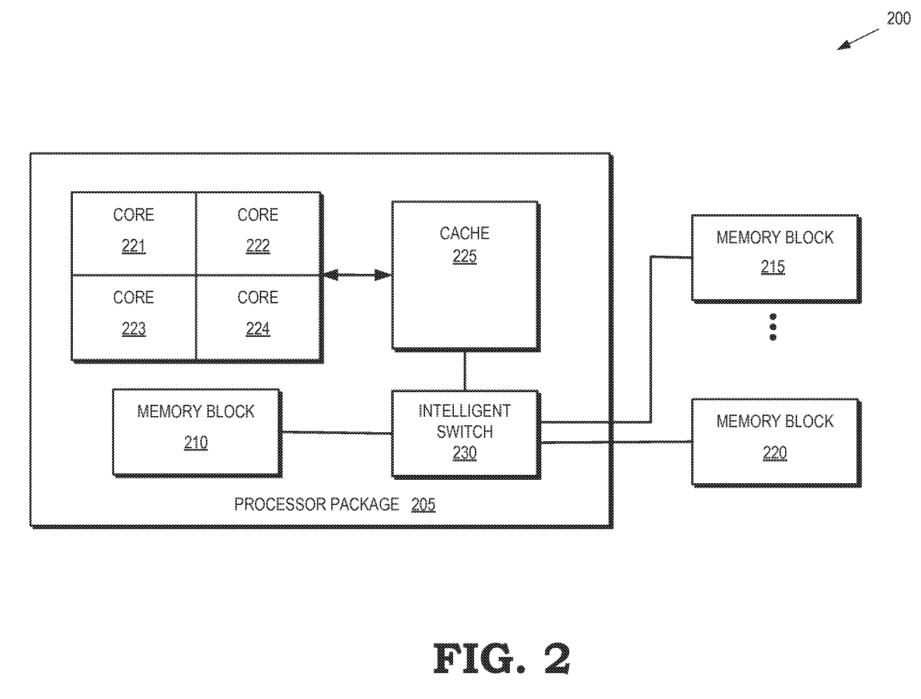

FIG. 2 is a block diagram of a processor system 200 including a processor package 205 that includes one or more internal memory blocks 210 is connected to one or more external memory blocks 215, 220 according to some embodiments. The internal memory blocks 210 and the external memory blocks 215, 220 may be the same or different type of memory and may operate according to the same memory access protocols or different memory access protocols. The processor package 205 includes one or more processor cores 221, 222, 223, 224 (which are referred to herein as “the processor cores 221-224”) that can execute instructions independently, concurrently, or in parallel. The processor package 205 also includes a cache 225 for caching copies of instructions or data from the memory blocks 210, 215, 220. Some embodiments of the cache 225 are implemented as a hierarchical cache system such as a cache system that includes an L1 cache, an L2 cache, an L3 cache, and the like. The components of the processor package 205 may be fabricated on a single die, substrate, or chip.

An intelligent switch 230 is implemented as an integral part of the processor package 205. The intelligent switch 230 is connected to the internal memory block 210, the external memory blocks 215, 220, and the cache 225, but is external to, or not part of, the cores of the processor package 205. The intelligent switch 230 provides separate data paths between the internal memory block 210, the external memory blocks 215, 220, and the cache 225. For example, the intelligent switch 230 may provide data paths between the internal memory block 210 and one or more of the external memory blocks 215 220. These data paths bypass the cache 225. For another example, the intelligent switch 230 may provide data paths between the memory block 210 and the cache 225. These data paths bypass the memory blocks 215, 220. For yet another example, the intelligent switch 230 may provide data paths between the external memory blocks 215, 220. These data paths bypass both the internal memory block 210 and the cache 225.

The intelligent switch 230 may perform one or more computations on data stored in one or more of the memory blocks 210, 215, 220 as the data is moved along one or more of the data paths between the memory blocks 210, 215, 220. Moving the data along the data paths may also be referred to as transferring the data along the data paths. Thus, these computations can be performed by the intelligent switch 230 without transferring the data to the cache 225 associated with the processor cores 221-224 and without involving the processor cores 221-224. Performing the computations in the intelligent switch 230 may improve power efficiency and performance at least in part because logic functions implemented in the intelligent switch 230 may be more power efficient than performing the same logic functions in a generalized processor core 221-224. Furthermore, data would not need to be transferred to the cache 225, thereby reducing cache usage and cache pollution. The intelligent switch 230 may also move data between the memory blocks 210, 215, 220 and the cache 225, e.g., to allow the processor cores 221-224 to access the data from the cache 225 and perform other computations on the data. The intelligent switch 230 can therefore perform computations in a pipelined manner on the data while simultaneously or concurrently moving the data between the memory blocks 210, 215, 220 or the cache 225.

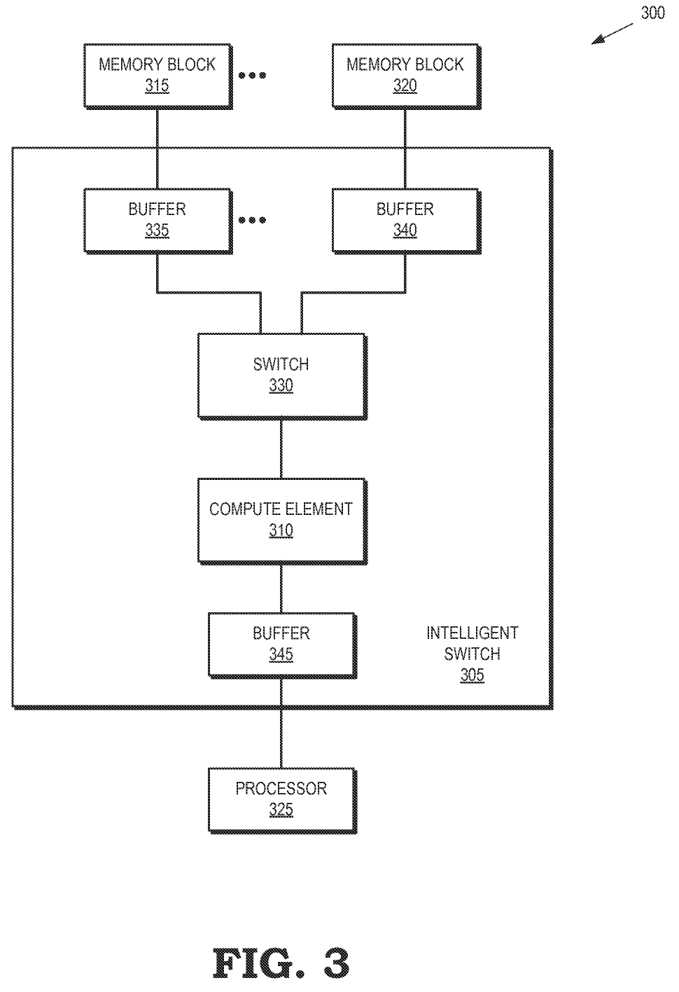

FIG. 3 is a block diagram of a processing system 300 including an intelligent switch 305 that implements an in-line compute element 310 according to some embodiments. The compute element 310 is used to perform a predetermined set of computations on data that may be provided to the compute element 310 in one or more data packets. The compute element 310 may be a programmable element (such as a processor or field programmable gate array, FPGA) or fixed function logic (such as an application-specific integrated circuit, ASIC). Some embodiments of the compute element 310 support higher level algorithms or execution of full applications.

The intelligent switch 305 is connected to a plurality of memory blocks 315, 320, which may be the same or different type of memory and may operate according to the same memory access protocols or different memory access protocols. The memory blocks 315, 320 may be a part of a memory module such as the memory modules 101-103 shown in FIG. 1. The intelligent switch 305 is also connected to a processor 325. Some embodiments of the processor 325 are implemented as one or more processor cores that can execute instructions independently, concurrently, or in parallel.

A switch 330 is implemented in the intelligent switch 305 and is connected to the compute element 310. Some embodiments of the switch 330 include crossbar switches or data rearrangement logic that supports swapping, redirecting, or routing data within the intelligent switch 305. Buffers 335, 340, 345 temporarily store information received from the corresponding memory blocks 315, 320 or the processor 325 before providing this information to the switch 330 or the compute element 310. The buffers 335, 340, 345 also temporarily store information received from the switch 330 or the compute element 310 before providing this information to the corresponding memory blocks 315, 320 or the processor 325.

The intelligent switch 305 supports data paths that interconnect the memory blocks 315, 320 and the processor 325 via the switch 330. For example, a data path may support moving data packets from the memory block 315 to the buffer 335, from the buffer 335 to the switch 330, from the switch 330 to the buffer 340, and on to the memory block 320. The intelligent switch 305 may also selectively include the compute element 310 in one or more of the data paths so that the compute element 310 can perform one or more computations on data stored in one or more of the memory blocks 315, 320 as the data is moved along a data path between the memory blocks 315, 320. Some embodiments of the switch 330 selectively route data packets to the compute element 310 responsive to detecting a tag in the data packet. For example, a data path may support moving data packets from the memory block 315 to the buffer 335, from the buffer 335 to the switch 330, from the switch 330 to the compute element 310 (where one or more computations are performed on the data), from the compute element 310 back to the switch 330, from the switch 330 to the buffer 340, and on to the memory block 320 where the modified data is stored. Some embodiments of the compute element 310 may also be used to perform computation on data as it is moved from one of the memory blocks 315, 320 along a data path to the processor 325. For example, the data path may include the memory block 315, the buffer 335, the switch 330, the compute element 310, the buffer 345, and the processor 325.

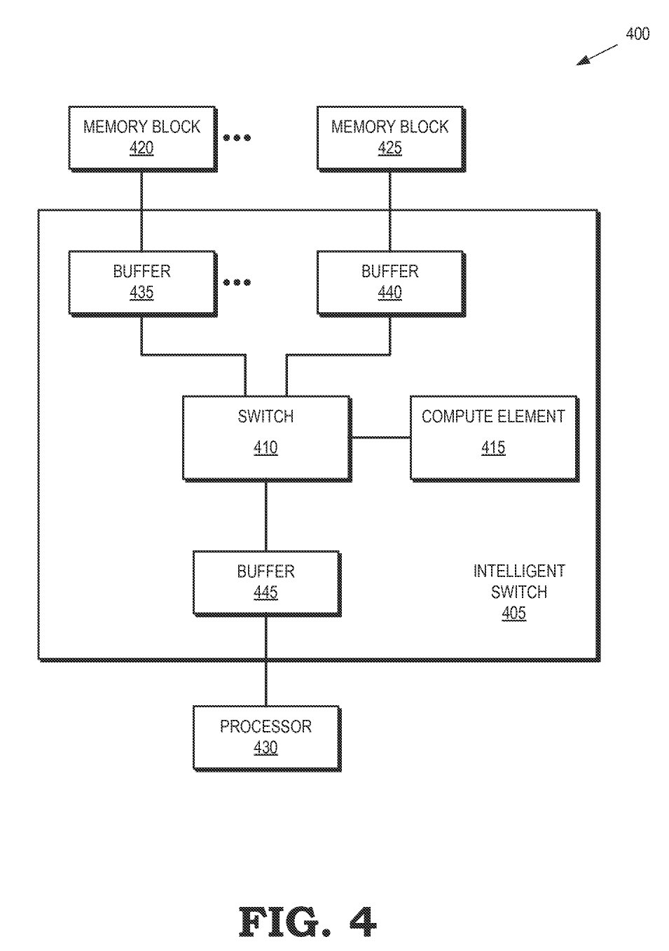

FIG. 4 is a block diagram of a processing system 400 including an intelligent switch 405 that implements a side-by-side switch 410 and compute element 415 according to some embodiments. The intelligent switch 405 is coupled to memory blocks 420, 425 and processor 430. The memory blocks 420, 425 may be a part of a memory module such as the memory modules 101-103 shown in FIG. 1. The intelligent switch 405 also includes buffers 435, 440, 445. The components of the processing system 400 may be configured and may operate in the substantially same manner as the corresponding components of the processing system 300 shown in FIG. 3. However, the processing system 400 differs from the processing system 300 because the compute element 415 is deployed side-by-side with the switch 410, whereas the compute element 310 is deployed in line with the switch 330 and the buffer 345, as shown in FIG. 3.

The intelligent switch 405 supports data paths that interconnect the memory blocks 420, 425 and the processor 430 via the switch 410. For example, a data path may support moving data packets from the memory block 420 to the buffer 435, from the buffer 435 to the switch 410, from the switch 410 to the buffer 440, and on to the memory block 425. The intelligent switch 405 may also selectively include the compute element 415 in one or more of the data paths so that the compute element 415 can perform one or more computations on data stored in one or more of the memory blocks 420, 425 as the data is moved along a data path between the memory blocks 420, 425. Some embodiments of the switch 410 selectively route data packets to the compute element 415 responsive to detecting a tag in the data packet. For example, a data path may support moving data packets from the memory block 420 to the buffer 435, from the buffer 435 to the switch 410, from the switch 410 to the compute element 415 (where one or more computations are performed on the data), from the compute element 415 back to the switch 410, from the switch 410 to the buffer 440, and on to the memory block 425 where the modified data is stored. Some embodiments of the compute element 415 may also be used to perform computation on data as it is moved from one of the memory blocks 420, 425 along a data path to the processor 430. For example, a data path may support moving data packets from the memory block 420 to the buffer 435, from the buffer 435 to the switch 410, from the switch 410 to the compute element 415 (where one or more computations are performed on the data), from the compute element 415 back to the switch 410, from the switch 410 to the buffer 445, and on to the processor 430.

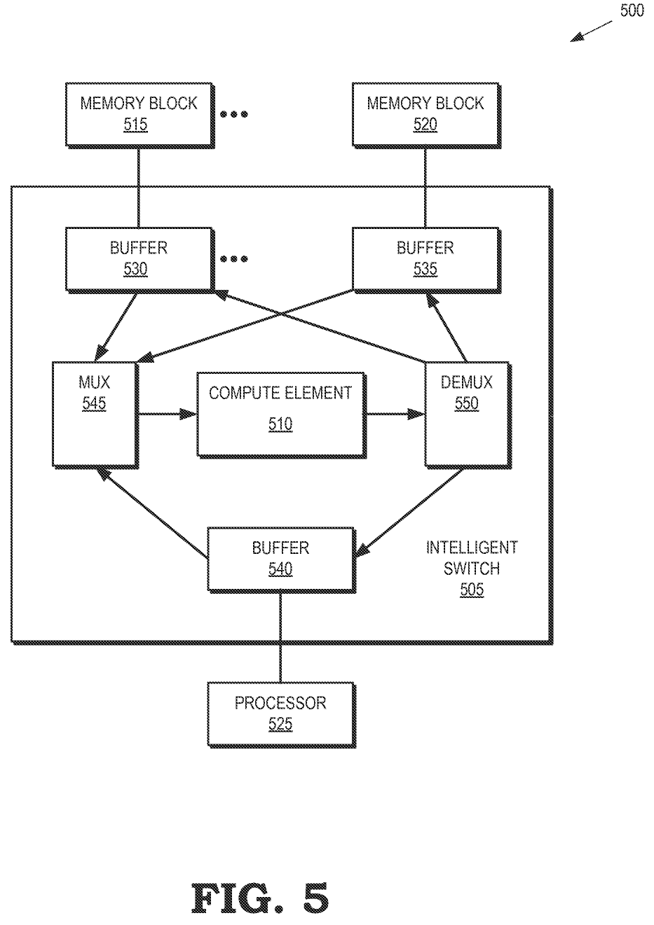

FIG. 5 is a block diagram of a processing system 500 including an intelligent switch 505 that implements multiplexing of data provided to a compute element 510 according to some embodiments. The intelligent switch 505 is coupled to memory blocks 515, 520 and processor 525. The memory blocks 515, 520 may be a part of a memory module such as the memory modules 101-103 shown in FIG. 1. The intelligent switch 505 also includes buffers 530, 535, 540. These components of the processing system 500 may be configured and may operate in the substantially same manner as the corresponding components of the processing system 300 shown in FIG. 3 or the corresponding components of the processing system 400 shown in FIG. 4. However, the processor system 500 differs from the processing systems 300, 400 because the switching function is performed by one or more multiplexers 545 and one or more de-multiplexers 550.

The intelligent switch 505 supports one or more data paths that interconnect the memory blocks 515, 520 or the processor 525. The data paths differ from the data paths in the intelligent switch 305 shown in FIG. 3 and the intelligent switch 405 shown in FIG. 4 because all the data paths include the compute element 510. For example, data paths may include the memory block 515, the buffer 530, the multiplexer 545 (which multiplexes data packets received from the memory blocks 515, 520 and the processor 525 into a single stream), the compute element 510, the de-multiplexer 550, which de-multiplexes data packets in a stream received from the compute element 510 and directs the de-multiplexed data packets to the appropriate memory blocks 515, 520 or processor 525. The compute element 510 selectively performs computations on the received data or bypasses performing computations so that the received data passes through the compute element 510 unmodified. Some embodiments of the compute element 510 selectively perform or bypass performance of computations on data in a received data packet responsive to detecting a tag in the data packet.

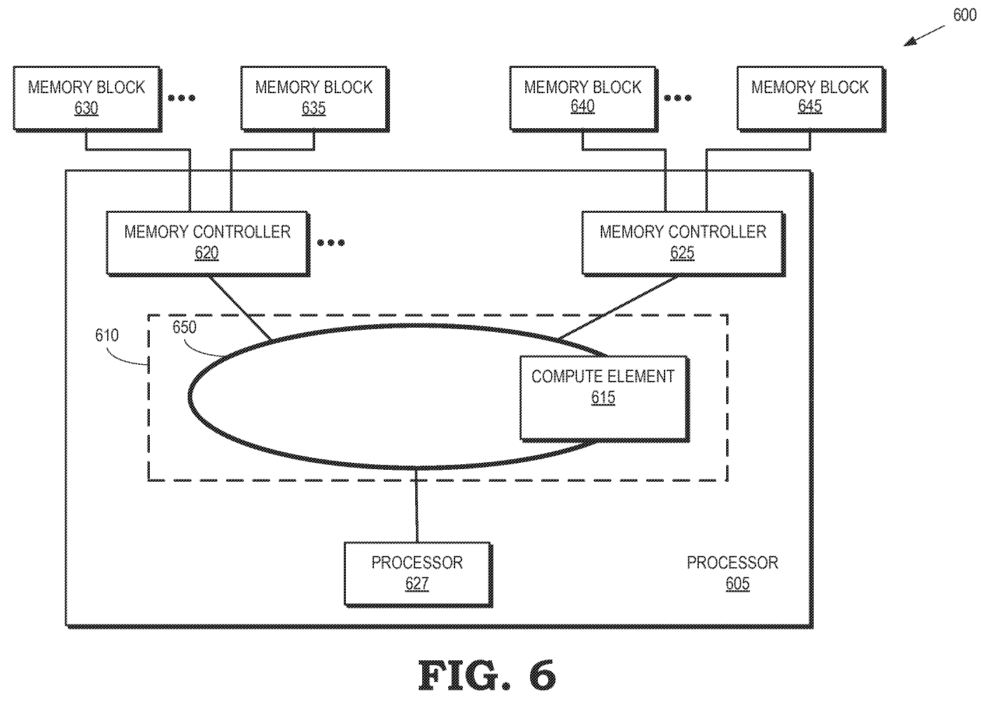

FIG. 6 is a block diagram of a processing system 600 including a processor package 605 that integrates an intelligent switching function 610 with a compute element 615 according to some embodiments. The processor package 605 may be implemented on a single chip, die, or substrate. The processor package 605 includes a plurality of memory controllers 620, 625 and a processor 627. The memory controllers 620, 625 manage the flow of data to and from corresponding memory blocks 630, 635, 640, 645. The memory blocks 630, 635, 640, 645 may be a part of a memory module such as the memory modules 101-103 shown in FIG. 1. The intelligent switching function 610 includes an intelligent on-chip switch network 650 that is integrated with the compute element 615. The on-chip switch network 650 shown in FIG. 6 is implemented as a ring switching network, but other embodiments may implement other configurations of the on-chip switch network 650.

The switch network 650 provides data paths between the memory blocks 630, 635, 640, 645 or the processor 627. The switch network 650 may also selectively route data to the compute element 615 so that the compute element 615 may perform one or more computations using the data as the data is moved along the data paths between the memory blocks 630, 635, 640, 645 or the processor 627. Some embodiments of the on-chip switch network 650 selectively route data packets to the compute element 615 responsive to detecting a tag in the data packet. For example, if the on-chip switch network 650 detects a tag in a data packet received from the memory controller 620, the on-chip switch network 650 may route the data packet to the compute element 615 so that the compute element 615 can perform one or more computations on or using the data in the data packet before the data packet is routed to a destination, e.g., one of the memory blocks 630, 635, 640, 645 or the processor 627.

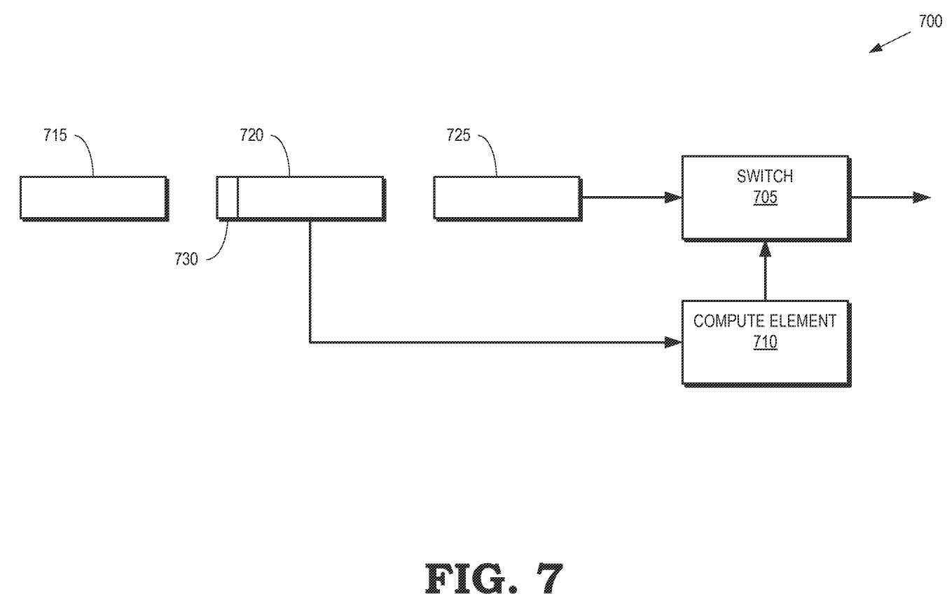

FIG. 7 is a block diagram of a portion 700 of an intelligent switch according to some embodiments. The portion 700 may be implemented as a portion of the intelligent switch 125 shown in FIG. 1, the intelligent switch 230 shown in FIG. 2, the intelligent switch 305 shown in FIG. 3, the intelligent switch 405 shown in FIG. 4, the intelligent switch 505 shown in FIG. 5, or the intelligent switching function 610 shown in FIG. 6. The portion 700 includes a switch 705 and a compute element 710. The portion 700 receives a stream of data packets 715, 720, 725 that include data received from one or more memory blocks, processors, or processor cores. The packet 725 does not include a tag indicating that the data in the packet 725 is to be provided to the compute element 710 for computation or modification. The intelligent switch therefore selectively routes the packet 725 directly to the switch 705, which routes the packet 725 to its destination. The packet 720 includes a tag 730 indicating that the data in the packet 720 is to be provided to the compute element 710 for computation or modification. The intelligent switch therefore selectively routes the packet 720 to the compute element 710, which performs a computation or modification and then provides the (possibly modified) packet 720 to the switch 705 to be routed to its destination.

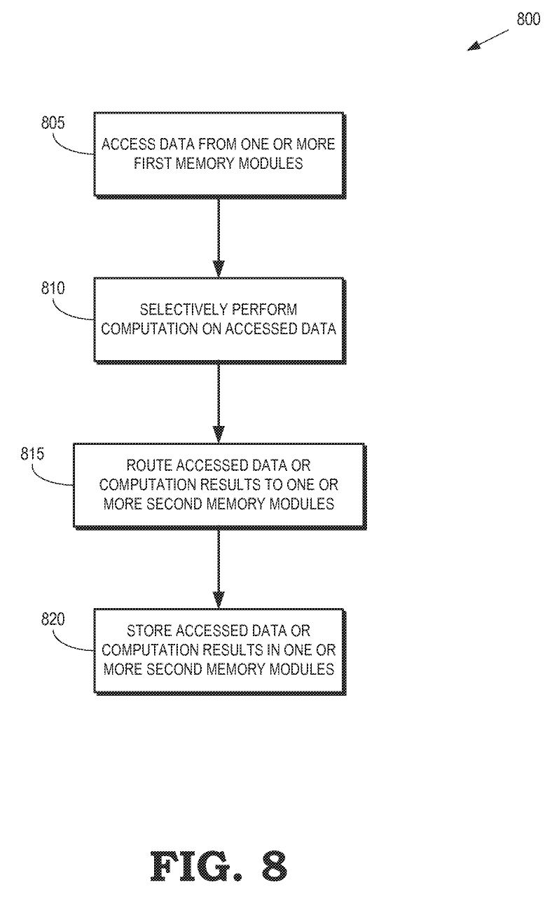

FIG. 8 is a flow diagram of a method 800 for selectively performing computations on data along a data path between memory blocks or an external processor according to some embodiments. The method 800 may be implemented in some embodiments of the intelligent switch 125 shown in FIG. 1, the intelligent switch 230 shown in FIG. 2, the intelligent switch 305 shown in FIG. 3, the intelligent switch 405 shown in FIG. 4, the intelligent switch 505 shown in FIG. 5, the intelligent switching function 610 shown in FIG. 6, or the portion 700 of the intelligent switch shown in FIG. 7. At block 805, the intelligent switch accesses data from one or more first memory modules. For example, the intelligent switch may receive data packets from the one or more first memory modules. At block 810, the intelligent switch selectively performs computations using the accessed data. For example, as discussed herein, the intelligent switch may selectively route data packets to a switch or a compute element based on the presence of a tag in the data packet. At block 815, the intelligent switch routes the accessed data and/or the computation results to one or more second memory modules, some of which may or may not be different than the first memory modules. At block 820, the accessed data and/or the computation results are stored in one or more of the second memory modules.

Embodiments of the intelligent switches and compute elements disclosed herein may be configured to perform numerous types of computations on the accessed data. For example, a compute element may be configured to perform in-row computation, e.g. accessing memory rows, modifying them on the fly, and then storing the modified row in its original location. Some embodiments of the intelligent switches therefore include a router interface to provide a direct path to fast memory row buffers in the memory blocks. For example, tight fast-capacity memory integration may be implemented using interfaces in a stacked die implementation of memory blocks or memory modules. Such an option would allow performing in-row buffer interleaved computation by sourcing operands and placing results directly from/to row buffers. The data objects may be located in memory in such a way that the element-wise data that is required for computation is available with minimum row opening and closing operations to reduce bank conflicts between the memory blocks. In addition, the memory blocks may include multiple row buffers to support interleaved computation with row opening and closing, which may relax the requirement for strictly aligned data placement for such in-row buffer compute.

Some embodiments of the intelligent switches and compute elements perform in-stream computations such as monitoring data stream that goes through the intelligent switch, catching specially tagged packets and performing compute modifications on the data in these packets, as discussed herein. Some embodiments of the intelligent switch and compute elements perform controlled computation so that some of the computation functions can be integrated as part of the memory die themselves and coordinated under the control of the intelligent switch in conjunction with its own functions. Data structure-oriented computation may also be performed by the intelligent switch and compute elements. For example, the intelligent switch may mediate sequences of writes from a processor to address ranges within the memory blocks or memory modules, enabling the efficient implementation of data structures such as stacks and queues without the need for the processor to incur the overhead of manipulating head and tail pointers.

The intelligent switches and the compute elements may also be configured to perform one or more of the following computations:
Element-wise array operations
Serial operations. For example, the intelligent switch and compute element may perform serial operations with loop-carried dependencies. If the computations are done by the intelligent switch and the compute element, the access latency is smaller than external access latency required if the computations are done in a processor external to the intelligent switch. For example, if an index of the next array access depends on the result of computation with the current array data and there is some uncertainty in the result of the computation. If such an operation is performed by the external processor, the larger access latency would be accumulated and degrade the performance significantly. In contrast, performing the computations in the compute unit of the intelligent switch for large streams with serial random access would provide a benefit. Random access to the memory blocks generates a distribution profile that results in good spatial or temporal access locality, which may improve the performance of the external processor due to increased hits in a cache associated with the processor. Size of the data matters since for large size, the eviction would degrade benefits from cache.
Reduction operations. Reduction (e.g., sum) can be performed on the array while accessing it in a memory block that provides high capacity, performing computation in the intelligent switch, storing intermediate results in a different memory block that provides access at low latencies, and forwarding the result to a processor external to the intelligent switch.
Array initialization. An intelligent switch can support pattern-based array initialization such as B=[2*x for x in A]. Initialization of the entire array may not be needed and the intelligent switch may perform element-wise initialization for each accessed element of the array. Hence, the initialization can be done in the background (e.g., concurrently with external accesses) or responsive to particular events. For example, if a read request comes in for a certain datum, the whole row containing that datum is initialized at that time. Some embodiments of the intelligent switch (or other entity) keep track of which rows were initialized. The initialization may be done in the background while an external processor performs other activities (maybe even random rows). When a host process accesses this array a page fault may occur, in which case the intelligent switch provides a handler to the allocated array and initialization continues in the background and is being directed on the row access basis.
Atomic operations.
Broadcasts.
Gather/scatter.
Pointer indirection/chasing. For example, if an external processor requests to access the elements of one array addressed by elements of another array, then both arrays can be accessed internally by the intelligent switch and the elements of the required array stored in a memory block that provides high speed access. The elements of the required array may be concurrently forwarded to the external processor.
Data compression and encryption.
Error correction and detection.
Data reordering (e.g., matrix transpose).
Pre-processing of raw sensor data (e.g., images from a camera) stored in capacity memory.
Customized operations or full applications, depending on programmability supported.
Support for tracking and manipulating metadata for in-memory data structures.

In some embodiments, the apparatus and techniques described above are implemented in a system comprising one or more integrated circuit (IC) devices (also referred to as integrated circuit packages or microchips), such as the intelligent switch described above with reference to FIGS. 1-8. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
a plurality of memory blocks; and
a computation-enabled switch that provides data paths between the plurality of memory blocks, and wherein the computation-enabled switch is to perform at least one computation on data stored in at least one of the plurality of memory blocks during transfer of the data along at least one data path between the plurality of memory blocks.

2. The apparatus of claim 1, wherein the computation-enabled switch is to perform at least one of swapping, redirecting, and routing the data along the at least one data path between the plurality of memory blocks.

3. The apparatus of claim 2, wherein the data is transferred along the at least one memory path between the plurality of memory blocks in at least one packet, and wherein the computation-enabled switch is to detect at least one tag associated with the at least one packet including the data and direct the at least one packet to a compute element in response to detecting the at least one tag.

4. The apparatus of claim 2, wherein the computation-enabled switch comprises:
a switch to swap, redirect, or route the data along the at least one data path between the plurality of memory blocks; and
a compute element to perform the at least one computation on the data as the data during transfer of the data along the at least one data path.

5. The apparatus of claim 4, wherein:
the computation-enabled switch comprises a plurality of buffers associated with the plurality of memory blocks, and
the plurality of buffers store data received from the plurality of memory blocks and store data received from the switch.

6. The apparatus of claim 2, wherein the computation-enabled switch comprises at least one multiplexer to swap, redirect, or route the data along the at least one data path between the plurality of memory blocks.

7. The apparatus of claim 2, wherein the computation-enabled switch comprises an on-chip switch network integrated with a compute element.

8. The apparatus of claim 1, wherein the plurality of memory blocks comprise:
at least one first memory block that operates according to a first memory access protocol; and
at least one second memory block that operates according to a second memory access protocol that is different than the first memory access protocol.

9. The apparatus of claim 1, further comprising:
a processor connected to the computation-enabled switch, wherein the processor is to:
receive data stored in at least one of the plurality of memory blocks from the computation-enabled switch; and
perform at least one operation on the received data, and
wherein the computation-enabled switch is to bypass the processor during transfer of the data along the at least one data path between the plurality of memory blocks.

10. A method, comprising:
receiving, at a computation-enabled switch, data stored in at least one of a plurality of memory blocks connected to the computation-enabled switch, wherein the computation-enabled switch provides data paths between the plurality of memory blocks;
transferring data along at least one data path between the plurality of memory blocks provided by the computation-enabled switch; and
performing, at the computation-enabled switch, at least one computation on the data as the data is transferred along the at least one data path.

11. The method of claim 10, wherein the data is transferred along the at least one memory path between the plurality of memory blocks in at least one packet, and further comprising:
detecting, at the computation-enabled switch, at least one tag in the at least one packet containing the data; and
directing the at least one packet to a compute element in response to detecting the at least one tag, wherein the compute element is to perform the at least one computation on the data.

12. The method of claim 10, further comprising:
performing, at the computation-enabled switch, at least one of swapping, redirecting, and routing the data along the at least one data path between the plurality of memory blocks.

13. The method of claim 10, further comprising:
bypassing a processor connected to the computation-enabled switch during transfer of the data along the at least one data path between the plurality of memory blocks.

14. An apparatus, comprising:
at least one processor core;
a plurality of memory blocks; and
an computation-enabled switch connected to the at least one processor core and the plurality of memory blocks, wherein the computation-enabled switch provides data paths between the plurality of memory blocks that bypass the at least one processor core, and wherein the computation-enabled switch is to perform at least one computation on data stored in at least one of the plurality of memory blocks during transfer of the data along at least one data path that bypasses the at least one processor core.

15. The apparatus of claim 14, further comprising:
at least one cache deployed between the at least one processor core and the computation-enabled switch, wherein the data paths provided by the computation-enabled switch between the plurality of memory blocks bypass the at least one cache.

16. The apparatus of claim 14, wherein the computation-enabled switch is to perform at least one of swapping, redirecting, and routing the data along the at least one data path between the plurality of memory blocks.

17. The apparatus of claim 16, wherein the data is transferred along the at least one memory path between the plurality of memory blocks in at least one packet, and wherein the computation-enabled switch is to detect at least one tag associated with the at least one packet including the data and direct the at least one packet to a compute element in response to detecting the tag.

18. The apparatus of claim 16, wherein the computation-enabled switch comprises a switch to perform at least one of swapping, redirecting or routing the data along the at least one data path between the plurality of memory blocks and a compute element to perform the at least one computation on the data during transfer of the data along the at least one data path.

19. The apparatus of claim 14, further comprising:
a plurality of memory controllers associated with the plurality of memory blocks.

20. The apparatus of claim 14, wherein the plurality of memory blocks comprise at least one first memory block that operates according to a first memory access protocol and at least one second memory block that operates according to a second memory access protocol that is different than the first memory access protocol.
